(19) United States
(12) Patent Application Publication
(10) Pub. No.: US 2026/0063277 A1
(43) Pub. Date: Mar. 5, 2026

(54) WORK LAMP

(71) Applicant: SHENZHEN AURORA TECHNOLOGY LIMITED, Shenzhen (CN)

(72) Inventor: Qingbo XIE, Shenzhen (CN)

(73) Assignee: SHENZHEN AURORA TECHNOLOGY LIMITED, Shenzhen (CN)

(21) Appl. No.: 19/298,590

(22) Filed: Aug. 13, 2025

(30) Foreign Application Priority Data
Sep. 5, 2024 (CN) 202422181017.3

(51) Int. Cl. F21V 19/00; F21V 29/70

(52) U.S. Cl. CPC F21V 19/003; F21V 29/70

(57) ABSTRACT

A work lamp includes a heat dissipation housing, a mounting boss, a first light-emitting assembly and a second light-emitting component. The heat dissipation housing is provided with an accommodating cavity with an opening; the mounting boss is provided at the accommodating cavity; the first light-emitting lamp board is mounted on a side of the mounting boss, the reflector passing through the mounting boss and being mounted in the accommodating cavity; the second light-emitting component includes a second light-emitting lamp board and a light guide, the light guide is used for leading out the light emitted by the second light-emitting lamp board.

### CROSS-REFERENCE TO RELATED APPLICATIONS

This application claims priority to Chinese Patent Application No. 202422181017.3, filed on September 5, 2024, the entire contents of which are incorporated herein by reference.

### TECHNICAL FIELD

The present application relates to the technical field of lamps, and in particular relates to a work lamp.

### BACKGROUND

At present, the lamp board assembly of a lamp usually consists of a lamp board, a reflector and lamp beads, and the reflector is sleeved outside the lamp beads to form light towards the light outlet. However, in this structure, the lamp beads are arranged opposite to the light outlet, which is prone to the problem that the brightness of the lamp beads is the highest and the irradiation direction is single, resulting in uneven brightness. Moreover, there are many stacked structures in the thickness direction of the whole lamp, leading to a large lamp volume.

### SUMMARY

The main purpose of the present application is to propose a work lamp, aiming at that the light emitted by the first light-emitting lamp board provided in the present application is reflected by the reflector for emission along the direction of the opening to form the main lighting. The light emitted by the second light-emitting lamp board is exported by the light guide to provide even background light to obtain softer light. The mounting boss provides a fixed position for the first light-emitting assembly and the second light-emitting component, so that the layout in the accommodating cavity is reasonable and compact, so as to improve the integrality and aesthetic appeal of the work lamp.

To realize the above purpose, the present application proposes a work lamp, the work lamp includes:

a heat dissipation housing;

a mounting boss;

a first light-emitting assembly; and

a second light-emitting component;

wherein, the heat dissipation housing is provided with an accommodating cavity with an opening;

the mounting boss is provided at the accommodating cavity;

the first light-emitting assembly includes a first light-emitting lamp board and a reflector, the first light-emitting lamp board is mounted on a side of the mounting boss, the reflector passing through the mounting boss and being mounted in the accommodating cavity, the reflector is wrapped around an outer edge of the first light-emitting lamp board so as to adjust the light-emitting direction of the first light-emitting lamp board through the reflector; and

the second light-emitting component includes a second light-emitting lamp board and a light guide, the second light-emitting lamp board is mounted on a side of the mounting boss away from the cavity bottom wall of the accommodating cavity, the light guide is mounted on one side of the second light-emitting lamp board far from the first light-emitting lamp board; and the light guide is used for leading out the light emitted by the second light-emitting lamp board.

In an embodiment, the reflector is provided with a through hole that the mounting boss and the first light-emitting lamp board pass through, and the inner wall surface of the reflector is a cup surface, and the light emitted by the first light-emitting lamp board irradiates the opening through the cup surface.

In an embodiment, the work lamp also includes a driving board, the driving board includes a base plate and a control circuit, the base plate is mounted on the cavity bottom wall of the accommodating cavity through the mounting boss, the control circuit is provided on the base plate, and the control circuit is electrically connected to the first light-emitting lamp board and the second light-emitting lamp board.

In an embodiment, the light guide includes a body and a light guide column, the body is a hollow ring with two ends penetrating through, and the light guide column is provided at the middle position of the body; and the light guide column cover is provided above the second light-emitting lamp board, and the light emitted by the second light-emitting lamp board is led out through the light guide column.

In an embodiment, a cover cavity with an accommodating opening is formed on one side of the light guide column facing the second light-emitting lamp board, and the cover cavity is used for covering the second light-emitting lamp board.

In an embodiment, the material of the light guide column is transparent or translucent.

In an embodiment, the work lamp also includes multiple lamp beads which are distributed on the base plate at equal intervals in a ring shape, the control circuit is electrically connected to each lamp bead, the body is covered above the lamp beads, and the light emitted by the lamp beads is led out through the body.

In an embodiment, the work lamp also includes a pressing block, the pressing block is used for mounting the first light-emitting lamp board on the mounting boss, and the second light-emitting lamp board is mounted on one side of the pressing block far away from the first light-emitting lamp board.

In an embodiment, the work lamp also includes a transparent lampshade and a lamp cover, the transparent lampshade is used for covering the opening, and the lamp cover is covered on the peripheral edge of the heat dissipation housing to lock the transparent lampshade to the heat dissipation housing.

In an embodiment, the work lamp also includes a support, the support includes a frame and two connecting arms, the two connecting arms are mounted at two sides of the frame at intervals, and each connecting arm is rotatably connected to two sides of the heat dissipation housing respectively.

The technical scheme of the present application is that, the heat dissipation housing is provided with an accommodating cavity with an opening; the mounting boss is provided at the accommodating cavity; the first light-emitting assembly includes a first light-emitting lamp board and a reflector, the first light-emitting lamp board is mounted on a side of the mounting boss, the reflector passing through the mounting boss and being mounted in the accommodating cavity, the reflector is wrapped around an outer edge of the first light-emitting lamp board so as to adjust the light-emitting direction of the first light-emitting lamp board through the reflector. The light emitted by the first light-emitting lamp board provided in the present application is reflected by the reflector for emission along the direction of the opening to form the main lighting.

The second light-emitting component includes a second light-emitting lamp board and a light guide, the second light-emitting lamp board is mounted on one side of the mounting boss away from the cavity bottom wall of the accommodating cavity, the light guide is mounted on one side of the second light-emitting lamp board far from the first light-emitting lamp board. The light guide is used for leading out the light emitted by the second light-emitting lamp board to provide even background light to obtain softer light. The mounting boss provides a fixed position for the first light-emitting assembly and the second light-emitting component, so that the layout in the accommodating cavity is reasonable and compact, so as to improve the integrality and aesthetic appeal of the work lamp.

### BRIEF DESCRIPTION OF THE DRAWINGS

In order to more clearly illustrate the embodiments of the present application or the technical solutions in the prior art, the drawings required for use in the embodiments or the description of the prior art will be briefly introduced below. Obviously, the drawings described below are only some embodiments of the present application. For ordinary technicians in this field, other drawings can be obtained based on the structures shown in these drawings without paying creative work.

FIG. 1 is a structural schematic diagram of a work lamp provided according to an embodiment of the present application.

FIG. 2 is an explosive view of the work lamp according to an embodiment of the present application.

The realization, functional features, and advantages of the purpose of the present application will be further explained in conjunction with the embodiments with reference to the drawings.

### DETAILED DESCRIPTION OF THE EMBODIMENTS

The technical solution in the embodiment of the present application will be clearly and completely described below in combination with the attached drawings in the embodiment of the present application. Obviously, the described embodiment is only part of the embodiment of the present application, rather than all the embodiments. Based on the embodiment of the present application, all the other embodiments obtained by general technicians in this field without making creative labors shall fall into the scope of protection of the present application.

It is necessary to note that if directional instructions are mentioned in the present application embodiment (such as “up”, “down”, “front”, “rear”, “left”, “right”...), these directional instructions are only for illustrating the relative positional relationships or movements of different parts under certain postures. If the certain posture changes, the directional instructions shall also change accordingly.

In addition, if there is a description of “first” or “second” in the embodiment of the present application, the description of the “first” or “second” is only used for the description purpose but shall not be understood as indicating or implying the relative importance or implicitly indicating the quantity of the technical features. Thus, features defined as “first” and “second” may explicitly or implicitly include at least one feature. In addition, if “and/or” or “and/or” appears in the full text, its meaning includes three parallel schemes. With “A and/or B” as an example, including scheme A, scheme B, or both scheme A and scheme B. In addition, the technical schemes between all the embodiments can be mutually combined, but the combination must be based on the situation that the combination can be achieved by those of ordinary skill in the art, when the combination of the technical schemes has mutual contradiction or cannot be achieved, it shall be thought that the combination of the technical schemes does not exist, and the combination is not within the scope of protection required by the present application.

The present application proposes a work lamp, aiming at that the light emitted by the first light-emitting lamp board provided in the present application is reflected by the reflector for emission along the direction of the opening to form the main lighting. And the light emitted by the second light-emitting lamp board is exported by the light guide to provide even background light to obtain softer light. And the mounting boss provides a fixed position for the first light-emitting assembly and the second light-emitting component, so that the layout in the accommodating cavity is reasonable and compact, so as to improve the integrality and aesthetic appeal of the work lamp.

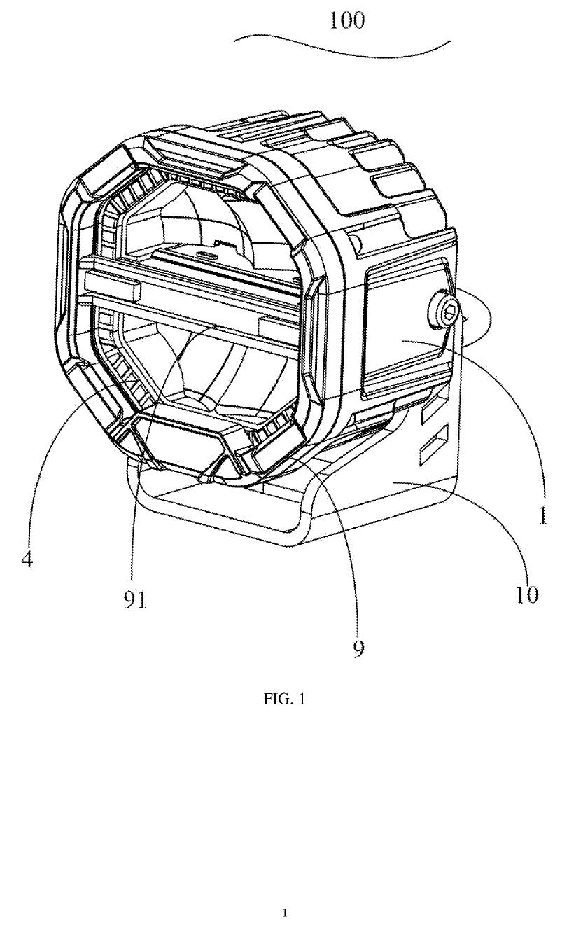

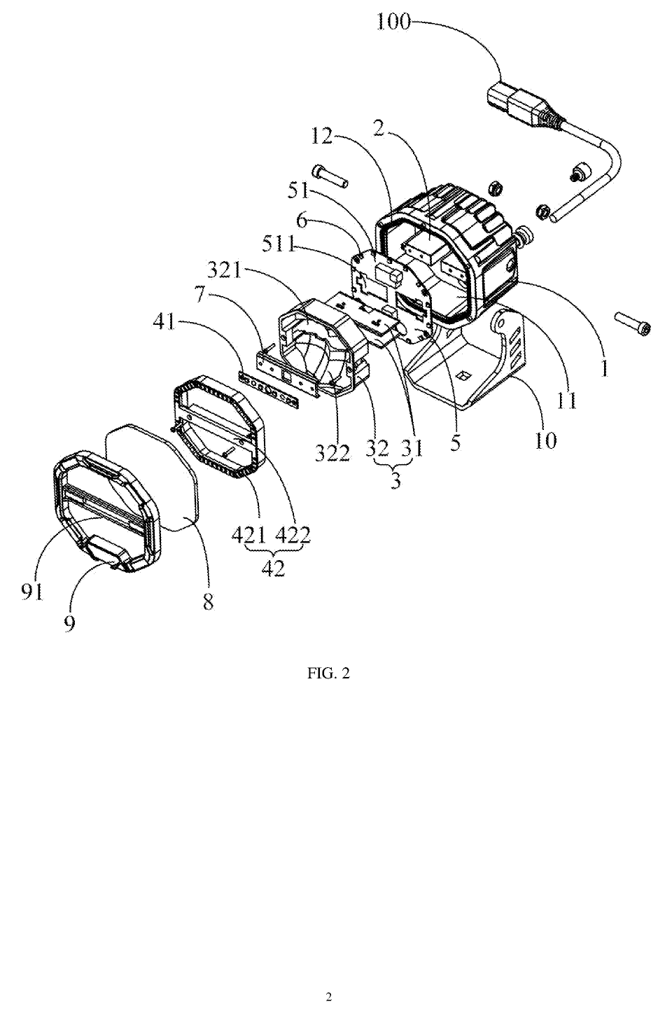

As shown in FIG. 1 and FIG. 2. In the embodiment of the present application, the work lamp 100 includes a heat dissipation housing 1, a mounting boss 2, a first light-emitting assembly 3, and a second light-emitting component 4.

The heat dissipation housing 1 is provided with an accommodating cavity with an opening 12.

The mounting boss 2 is provided at the accommodating cavity 11.

The first light-emitting assembly 3 includes a first light-emitting lamp board 31 and a reflector 32, the first light-emitting lamp board 31 is mounted on a side of the mounting boss 2, the reflector 32 passing through the mounting boss 2 and being mounted in the accommodating cavity 11, the reflector 32 is wrapped around an outer edge of the first light-emitting lamp board 31 so as to adjust the light-emitting direction of the first light-emitting lamp board 31 through the reflector 32.

The second light-emitting component 4 includes a second light-emitting lamp board 41 and a light guide 42, the second light-emitting lamp board 41 is mounted on a side of the mounting boss 2 away from the cavity bottom wall of the accommodating cavity 11, the light guide 42 is mounted on one side of the second light-emitting lamp board 41 far from the first light-emitting assembly 31. The light guide is used for leading out the light emitted by the second light-emitting lamp board 41.

In the embodiment, the work lamp 100 includes heat dissipation housing 1, mounting boss 2, first light-emitting assembly 3 and second light-emitting component 4. An accommodating cavity 11 with an opening 12 at one end is formed in the heat dissipation housing 1, the mounting boss 2 is provided at the accommodating cavity 11, the first light-emitting assembly 3 includes a first light-emitting lamp board 31 and a reflector 32. The first light-emitting assembly 31 is mounted on the side surface of the mounting boss 2, and the reflector 32 is mounted in the accommodating cavity 11 through the mounting boss 2; the reflector 32 is wrapped around the outer edge of the first light-emitting lamp board 31, i.e. first, the first light-emitting lamp board 31 is mounted on the mounting boss 2, and then, the reflector 32 is mounted in the accommodating cavity 11. The light emitted by the first light-emitting lamp board 31 is reflected by the reflector 32, and emits light toward the opening 12, thereby forming main lighting, so that the light-emitting direction of the first light-emitting lamp board 31 can be adjusted by the reflector 32. The second light-emitting component 4 includes a second light-emitting lamp board 41 and a light guide 42, the second light-emitting lamp board 41 is mounted on one side of the mounting boss 2 away from the cavity bottom wall of the accommodating cavity 11, the light guide 42 is mounted on one side of the second light-emitting lamp board 41 far from the first light-emitting assembly 31. Therefore, the light emitted by the second light-emitting lamp board 41 becomes even after passing through the light guide 42, and at the same time, the light is not too dazzling, so that even background light can be provided to obtain softer light.

It shall be further noted that, there are two of first light-emitting lamp board 31, and similarly, there are two of mounting boss 2. As shown in FIG. 2, it can be seen that the mounting boss 2 is rectangular, and each first light-emitting lamp board 31 is mounted on the long side of the mounting boss 2. And one side of each first light-emitting lamp board 31 is placed on the long side of one of the mounting boss 2, and the other side of each first light-emitting lamp board 31 is placed on the long side of another mounting boss 2, and two of first light-emitting lamp board 31 are provided with lamp beads 6 on one side away from the mounting boss 2.

At the same time, the heat dissipation housing 1 and the mounting boss 2 are integrally die-cast. That is, the heat dissipation housing 1 and the mounting boss 2 are a whole, having heat conduction and heat dissipation more quickly. The heat generated by the first light-emitting lamp board 31 is directly conducted to the heat dissipation housing 1 through the mounting boss 2, and then dissipated to the outside of the lamp body through the heat dissipation housing 1, so as to avoid the reduction of light efficiency or lamp damage caused by excessive internal temperature of the lamp body. The heat dissipation housing 1 is also provided with a wire passing hole connecting with the accommodating cavity 11, and the power cord of the work lamp 100 passes through the wire passing hole and is electrically connected with the first light-emitting lamp board 31 and the second l light-emitting lamp board 41 to supply power to the work lamp 100. It shall be noted that, the back of the heat dissipation housing 1 is designed as finned type, and the heat can be quickly dissipated to the outside air through the back fin, so that the heat dissipation efficiency can be improved, and the light efficiency can be prevented from being reduced or the work lamp 100 is damaged due to too high temperature inside work lamp 100.

In the embodiment, as shown in FIG. 2, the reflector 32 is provided with a through hole 321 that the mounting boss 2 and the first light-emitting lamp board 31 pass through, and the inner wall surface of the reflector 32 is a cup surface 322, and the light emitted by the first light-emitting lamp board 31 irradiates the opening 12 through the cup surface 322 to form the main lighting and ensure the normal use of work lamp 100.

In the embodiment, to ensure that the reflector 32 can be stably mounted in the accommodating cavity 11, the reflector 32 is provided with a through hole 321 that the mounting boss 2 and the first light-emitting lamp board 31 pass through. Further, when the reflector 32 is mounted, the reflector 32 can be stably placed in the accommodating cavity 11 only by aligning the through hole 321 with the mounting boss 2 and the first light-emitting lamp board 31. Meanwhile, the inner wall surface of the reflector 32 is the cup surface 322, and the light emitted by the first light-emitting lamp board 31 can be emitted through the cup surface 322 to form main lighting and irradiate the opening 12. It shall be noted that, the reflector 32 is an integral structure, ensuring structural stability and structural strength. It shall be noted that, the cup surface 322 is a condenser reflector 32 surface or a diffuser reflector 32 surface. When the cup surface 322 is a condenser reflector 32 surface, the light emitted from the cup surface 322 is concentrated and has a long range. When the cup surface 322 is a diffuser reflector 32 surface, the illumination area is relatively large.

In the embodiment, as shown in FIG. 2, the work lamp 100 also includes a driving board 5, the driving board 5 includes a base plate 51 and a control circuit, the base plate 51 is mounted on the cavity bottom wall of the accommodating cavity 11 through the mounting boss 2, the control circuit is provided on the base plate 51, and the control circuit is electrically connected to the first light-emitting lamp board 31 and the second light-emitting lamp board 41.

In the embodiment, the work lamp 100 also includes a driving board 5, the driving board 5 includes a base plate 51 and a control circuit, the control circuit is connected with an external power supply through a power cord. It shall be noted that, the control circuit drives the first light-emitting lamp board 31 and the second light-emitting lamp board 41 to emit light. This is a common structure in the field and will not be described in detail in this application. Meanwhile, to facilitate the installation of the base plate 51 in the accommodating cavity 11, a through hole 511 is formed in the base plate 51 for the mounting boss 2 to pass through, as shown in FIG. 2, so that the base plate 51 can be fixedly mounted on the cavity bottom wall of the accommodating cavity 11 by screws, so that the heat generated by the base plate 51 can be conducted to the outside through the heat dissipation housing 1. It shall be noted that, multiple components are also mounted on the base plate 51. It shall be noted that, the base plate 51 is in the prior art, therefore, there is no detailed explanation in this application.

In the embodiment, as shown in FIG. 2,the light guide 42 includes a body 421 and a light guide column 422, the body 421 is a hollow ring with two ends penetrating through, and the light guide column 422 is provided at the middle position of the body 421;

The light guide column 422 cover is provided above the second light-emitting lamp board 41, and the light emitted by the second light-emitting lamp board 41 is led out through the light guide column 422 to provide even background light to obtain softer light.

In the embodiment, the light guide 42 includes a body 421 and a light guide column 422, the body 421 is a hollow ring with two ends penetrating through, and the light guide column 422 is provided at the middle position of the body 421. It shall be noted that, the light guide 42 is an integral structure, ensuring structural stability and structural strength. Moreover, the two ends of the light guide column 422 are provided with mounting holes, so that the light guide 42 can be mounted above the second light-emitting lamp board 41 by screws, and the light guide column 422 is covered above the second light-emitting lamp board 41, so that when the second light-emitting lamp board 41 emits light, the light passes through the light guide column 422 and becomes more even, and at the same time, the light is not too dazzling, so as to obtain softer light.

At the same time, the body 421 is hollow, that is, the body 421 is provided with a light-transmitting port, and the light guide column 422 is provided at the middle of the body 421, so that the light-transmitting port is divided into two light-transmitting ports by light guide column 422, and the two light-transmitting ports are opposite to the cup surface 322 of the reflector 32, so that the light emitted by the first light-emitting lamp board 31 is irradiated to the opening 12 from the two light-transmitting ports under the reflection of the reflector 32.

In the embodiment, as shown in FIG. 2, a cover cavity with an accommodating opening is formed on one side of the light guide column 422 facing the second light-emitting lamp board 41, and the cover cavity is used for covering the second light-emitting lamp board 41, so that the light energy emitted by the second light-emitting lamp plate 41 is completely led out from the light guide column 422.

In the embodiment, a cover cavity with an accommodating opening is formed on one side of the light guide column 422 facing the second light-emitting lamp board 41, therefore, when the light guide 42 is mounted on the second light-emitting lamp board 41, the cover cavity is provided towards the second light-emitting lamp board 41, so that the light energy emitted by the second light-emitting lamp board 41 becomes even through the cover cavity, and the atmosphere is stronger.

In the embodiment, as shown in FIG. 2, the material of the light guide column 422 is transparent or translucent, which makes the light coming out through the light guide column 422 uniform, soft and not dazzling.

In the embodiment, as shown in FIG. 2, the work lamp also includes multiple lamp beads which are distributed on the base plate at equal intervals in a ring shape, the control circuit is electrically connected to each lamp bead, the body is covered above the lamp beads, and the light emitted by the lamp beads is led out through the body.

In the embodiment, the work lamp 100 also includes multiple lamp beads 6 which are distributed on the base plate 51 at equal intervals in a ring shape, and the control circuit is electrically connected to each lamp bead 6, when multiple lamp beads 6 are mounted on the bottom wall of the accommodating cavity 11 along with the base plate 51, the body 421 is just covered above the lamp beads 6, and the light emitted by multiple lamp beads 6 is just led out through the body 421. It shall be noted that, the overall size of the reflector 32 is smaller than that of the base plate 51, and the reflector 32 will not block the light emitted by the lamp beads 6 on the base plate 51.

It shall be further noted that, lamp beads 6 are LED lamp beads 6, and the lamp bead 6 can be monochromatic lamp beads 6, bicolor lamp beads 6, RGB lamp beads 6, RGBW lamp beads 6, and of course, they can also be other lamp beads 6, and there is no limitation in this application.

In the embodiment, as shown in FIG. 2, the work lamp 100 also includes a pressing block 7, the pressing block 7 is used for mounting the first light-emitting lamp board 31 on the mounting boss 2, and the second light-emitting lamp board 41 is mounted on one side of the pressing block far away from the first light-emitting lamp board 31.

In the embodiment, to stably install the first light-emitting lamp board 31 on the mounting boss 2, the work lamp 100 also includes a pressing block 7, and when the first light-emitting lamp board 31 is mounted on the side of the mounting boss 2, the first light-emitting lamp board 31 is locked on the mounting boss 2 by the pressing block 7. As shown in FIG. 2, the pressing block 7 is U-shaped and provided with a U-shaped groove. During installation, the two side walls of the U-shaped groove clamp the first light-emitting lamp board 31 on the mounting boss 2, and then the pressing block 7 is locked on the mounting boss 2 by screws.

In the embodiment, as shown in FIG. 1 and FIG. 2, the work lamp 100 also includes a transparent lampshade 8 and a lamp cover 9, the transparent lampshade 8 is used for covering the opening 12, and the lamp cover 9 is covered on the peripheral edge of the heat dissipation housing 1 to lock the transparent lampshade 8 to the heat dissipation housing 1. It shall be noted that, the lamp cover 9 is mounted on the heat dissipation housing 1 by screws, so that the transparent lampshade 8, the first light-emitting assembly 3 and the second light-emitting component 4 are stably mounted in the heat dissipation housing 1. At the same time, a cross bar 91 is provided at the middle of the lamp cover 9. When the lamp cover 9 is mounted on the heat dissipation housing 1, the cross bar 91 just blocks the light guide column 422 to ensure the beauty of the product. A patterned lamp can also be customized on the cross bar 91, and the light from the light guide column 422 can be irradiated through the customized pattern on the cross bar 91 for decoration.

In the embodiment, as shown in FIG. 1 and FIG. 2, the work lamp 100 also includes a support 10, the support 10 includes a frame and two connecting arms, the two connecting arms are mounted at two sides of the frame at intervals, and each connecting arm is rotatably connected to two sides of the heat dissipation housing 1 respectively. The support 10 is used to fix the external structure. For example, the bracket 10 is fixed to the body by bolts, and the heat dissipation housing 1 can be rotated to adjust the light-emitting angle of the work lamp 100.

The above is only an exemplary embodiment of the present application, and it does not limit the patent scope of the present application. Any equivalent structural transformation made by using the description and attached drawings of the present application under the technical concept of the present application, or direct/indirect application in other related technical fields are included in the patent protection scope of the present application.

What is claimed is:

1. A work lamp, comprising :
a heat dissipation housing;
a mounting boss;
a first light-emitting assembly; and
a second light-emitting component;
wherein the heat dissipation housing is provided with an accommodating cavity with an opening;
the mounting boss is provided at the accommodating cavity;
the first light-emitting assembly comprises a first light-emitting lamp board and a reflector, the first light-emitting lamp board is mounted on a side of the mounting boss, the reflector passing through the mounting boss and being mounted in the accommodating cavity, the reflector is wrapped around an outer edge of the first light-emitting lamp board so as to adjust the light emitting direction of the first light-emitting lamp board through the reflector; and
the second light-emitting component comprises a second light-emitting lamp board and a light guide, the second light-emitting lamp board is mounted on a side of the mounting boss away from the cavity bottom wall of the accommodating cavity, the light guide is mounted on one side of the second light-emitting lamp board far from the first light-emitting lamp board, and the light guide is used for leading out the light emitted by the second light-emitting lamp board.

2. The work lamp according to claim 1, wherein the reflector is provided with a through hole that the mounting boss and the first light-emitting lamp board pass through, and an inner wall surface of the reflector is a cup surface, and the light emitted by the first light-emitting lamp board irradiates the opening through the cup surface.

3. The work lamp according to claim 2, further comprising:
a driving board,
wherein the driving board comprises a base plate and a control circuit, the base plate is mounted on the cavity bottom wall of the accommodating cavity through the mounting boss, the control circuit is provided on the base plate, and the control circuit is electrically connected to the first light-emitting lamp board and the second light-emitting lamp board.

4. The work lamp according to claim 3, wherein:
the light guide comprises a body and a light guide column, the body is a hollow ring with two ends penetrating through, and the light guide column is provided at the middle position of the body; and
the light guide column cover is provided above the second light-emitting lamp board, and the light emitted by the second light-emitting lamp board is led out through the light guide column.

5. The work lamp according to claim 4, wherein a cover cavity with an accommodating opening is formed on one side of the light guide column facing the second light-emitting lamp board, and the cover cavity is used for covering the second light-emitting lamp board.

6. The work lamp according to claim 5, wherein a material of the light guide column is transparent or translucent.

7. The work lamp according to claim 4, further comprising:
multiple lamp beads which are distributed on the base plate at equal intervals in a ring shape,
wherein the control circuit is electrically connected to each lamp bead, the body is covered above the lamp beads, and the light emitted by the lamp beads is led out through the body.

8. The work lamp according to claim 1, further comprising:
a pressing block,
wherein the pressing block is used for mounting the first light-emitting lamp board on the mounting boss, and the second light-emitting lamp board is mounted on one side of the pressing block far away from the first light-emitting lamp board.

9. The work lamp according to claim 1, further comprising:
a transparent lampshade and a lamp cover,
wherein the transparent lampshade is used for covering the opening, and the lamp cover is covered on a peripheral edge of the heat dissipation housing to lock the transparent lampshade to the heat dissipation housing.

10. The work lamp according to claim 1, further comprising:
a support,
wherein the support comprises a frame and two connecting arms, the two connecting arms are mounted at two sides of the frame at intervals, and each connecting arm is rotatably connected to two sides of the heat dissipation housing respectively.
